(19) United States
(12) Patent Application Publication
(10) Pub. No.: US 2007/0016461 A1
(43) Pub. Date: Jan. 18, 2007

(54) Method for the scheduling and control of projects and production-phase business operation

(76) Inventor: Jacques Draperi, Guyancourt (FR)

Correspondence Address: LOWE HAUPTMAN GILMAN & BERNER, LLP, 1700 DIAGNOSTIC ROAD, SUITE 300, ALEXANDRIA, VA, 22314, US

(21) Appl. No.: 11/454,124

(22) Filed: Jun. 16, 2006

(30) Foreign Application Priority Data
Jun. 17, 2005 (FR) 05 06181

(51) Int. Cl. G05B 19/418; G06F 9/46

(52) U.S. Cl. 705/8

(57) ABSTRACT

A system for the management of business operations or projects that brings into play several users Uij comprises at least the following elements in combination: a management controller adapted to the reception of data proper to a business operation and to the updating of this data on the basis of information delivered by the users; a database containing the information needed for the management of a business operation or a project; one or more interfaces between the management controller and the users.

### BACKGROUND OF THE INVENTION

1. Field of the Invention

The invention relates to a method for the scheduling and control of business operations in the production phase or the deployment of projects in complex industrial environments involving multiple actors and multiple sites.

By convention, the term “business operation” is used with reference to the production of several copies of a same product whose manufacture can be distributed over several geographical sites (islands).

By convention, the term “project” is used with reference to the deployment on several geographical sites or islands of one or more processes that can be broken down into activities that can be listed for example in the form of checklists.

In the present description, the terms “business operation” and “project” will be used indistinguishably because the invention applies to both aspects.

It is situated in the field of program management.

2. Description of the Prior Art

In the face of the demand for improving the exposure of business operations in the mass production phase, it is necessary to have a tool available for ensuring permanent consistency of information, providing relevant (suitable) information to each actor in the business operation (each at his own level) and ensuring great simplicity of use.

The traditional project scheduling tools such as MicrosoftProject commercially distributed by the firm Microsoft, and many other tools can be used for dealing efficiently with the phases of development and industrial-scale manufacture. However, once it becomes a question of repetitive production requiring tracking and forecasts for each operation pertaining to a product line for each number of each article identified at each level in the tree structure of the business operation, this leads to an explosion in the number of lines of activity and soon becomes unmanageable.

GAPM (computer-assisted production management) tools respond more efficiently to this problem but, apart from the fact that their use is painstaking, they meet needs only partially. For example the following problems will be noted:
the impossibility of processing articles by their copy number. This possibility is an important characteristic is important because it enables a chronology to be kept and all the manufactured articles to be located,
The extremely cumbersome nature of the re-scheduling principle that has been observed,
The impossibility of taking account of articles returned for upgrading, repairs, returned as articles on loan, etc.

Excel tables, commonly used by persons responsible for management and control tasks, are as numerous as the actors and are often inconsistent with one another, thus causing consolidation to become a painstaking or even impossible task.

Through these tools, the state of progress of the business operation can thus be approximated at the cost of lengthy and costly manual or semi-automatic handling operations (entailing re-entries and data transfers).

At present, there are no tools for centralizing all the information that can be used for the easy production of all the indicators on the running of a business operation. This defect may be harmful to the consistency and relevance of the results and may lead to errors of judgment on corrective action to be undertaken.

### SUMMARY OF THE INVENTION

The invention proposes a system for the management of business operations or projects that brings into play several users Uij, the system comprising at least the following elements in combination:
a management controller adapted to the reception of data proper to a business operation and to the updating of this data on the basis of information delivered by the users,
a database containing the information needed for the management of a business operation or a project,
one or more interfaces between the management controller and the users.
   The method of the invention has especially the following advantages:
It provides coherency between different users of the running project, whatever their geographical site,
It can be used to obtain indicators on the deployment of a project or on the production obtained in a business operation,
It provides high visibility on the state of progress and forecasting of scheduled activities: calendar situation relative to a contractual timetable, indicators on the quality of the articles, valuation of articles in progress, chronology, cash-in and cash-out, identification of hard points . . .
The indicators on projects or business operations are currently produced through the involvement of all the persons holding the information by which these projects can be set up, and requires considerable energy.

### BRIEF DESCRIPTION OF THE DRAWINGS

Other features and advantages of the present invention shall appear more clearly from the following description of an example, given by way of an illustration that in no way restricts the scope of the invention, and from the appended figures, of which:

FIG. 1 is a drawing showing the deployment of the scheduling accessible to different users, and

FIG. 2 shows elements coming into play in the management of a business operation.

### MORE DETAILED DESCRIPTION

The management and scheduling tool of the invention comprises especially the following elements:
A central server hosting the database and possessing a multiple-station access point,
An administrator station,
User stations provided with an intuitive interface,
Extended graphic possibilities (representation of tables, graphs if any).

The programming languages used are, for example, PHB associated with JavaScript and HTML. These three languages are complementary, but any other language adapted to Web technologies can be used.

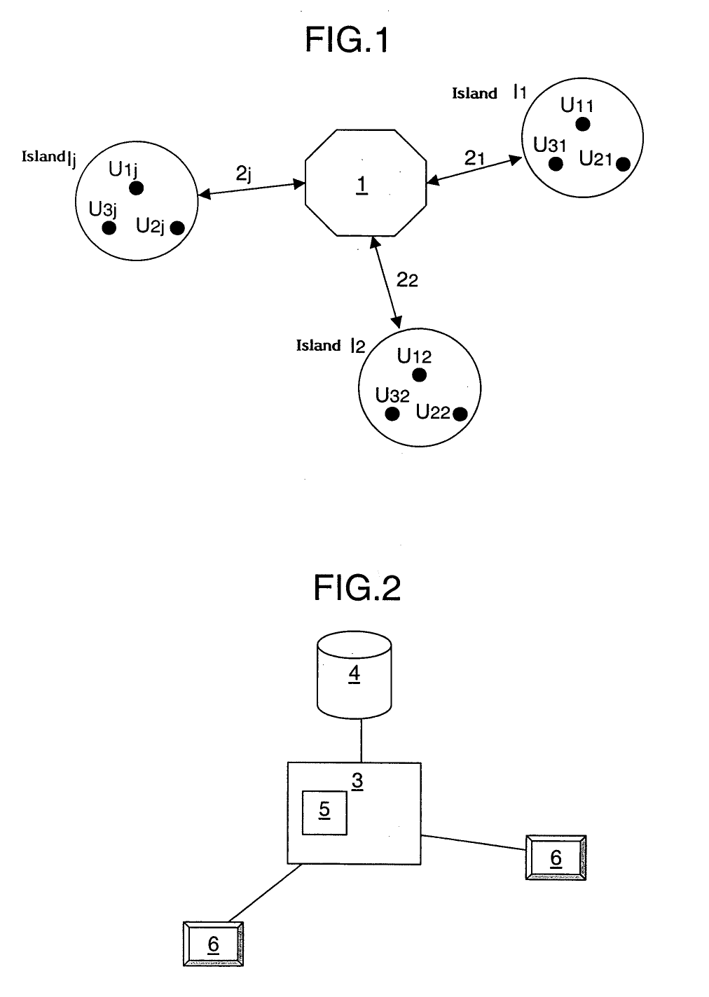

FIGS. 1 and 2 show an example of the deployment of a tool according to the invention.

The management system 1 comprises for example the functionalities 3, 4 and 5 developed in FIG. 2. The different users Uij, working on the same information, may be grouped together in islands Ij. The link between an island Ij and the management system is set up by means of appropriate interfaces 2j and an Internet link. Any other link having similar characteristics may be used.

FIG. 2 shows the management core 3 of the system, comprising especially a shared database 4, a management controller 5, display and information means 6 enabling the easy tracking of the state of the databases and the indicators generated by the system. The database 4 comprises especially the initial data proper to a business operation and data that evolves in the course of its development. The management controller 5 has notably the function of taking account of all the information coming from the different users, generating indicators pertaining to the tracking of the running of the business operation.

It must be noted that, the indicators generated by the management system are accessible to authorized users wherever they are located.

A database MySQL is used for example for the storage of the information. Any other database offering similar functions may be used. The size and structure of the database are determined, for example, according to the application. The database is constituted by several fields accessible to the different users who enter information into them.

Each of the different users has a right of access to the different pieces of information and to the fields that they are authorized to modify. The hierarchical ordering of the rights is determined, for example, according to the activity and responsibilities of a user. The processor of the management controller of the system is notably adapted to managing conflicts of access to the fields of the database. This conflict management can be done according to rules known to those skilled in the art.

An example of the operation of such a tool is described here below with reference to the running of a business operation in the production phase. In a first stage, data on the business of a firm are entered into a tool. The initial scheduling of a business operation is determined notably on the basis of a countdown schedule, and possibilities of re-scheduling are offered in the event of modifications. A chronological presentation of the modifications makes it possible, when the business balance-sheet is made, to view the successive scheduling operations and thus capitalize on experience. The scheduling of a business operation necessitates, for example, knowledge of the contractual timetable, the structuring and layout pattern of the business operation and the manufacturing lines in which the different operations to be performed are described and for which it is sought to keep a trace and record the chronology.

The timetable includes for example the dates of acceptance or delay: each piece of equipment is to be delivered in a certain number of copies according to a delivery timetable.

The structuring and layout pattern of a business operation represents its structure. A business operation is constituted notably by one or more products formed by articles, themselves constituted by one or more articles up to the elementary articles delivered by the suppliers and/or the sub-contractors in the business operation.

The lines may be defined as a set of elementary operations to be performed to complete the manufacture of an article.

When the scheduling is recorded, the tool according to the invention is used by all the actors intervening in the production cycle of the business operation. The principle consists notably in registering the articles coming from the sub-contractor or the supplier at entry into a production island. To this end, it suffices, for example, to select the type of article in a scrolling menu and enter its copy number. A possibility is offered for the simultaneous entry of several copies of a same type of article. The tool ascertains that the copies do not already exist in the base. This makes it possible, especially, to detect duplicates if any as soon as the internal production cycle is begun.

When they are entered, the articles become available for the next step and appear in green on a, indicator of the “state of the elementary articles” or “state of the compound articles”. The same principle is applied to higher-level articles. For example, the creation of a copy of a package article is declared. A link makes it possible especially to constitute this package by means of the elementary articles initially recorded and available. The progress of its production cycle is recorded by validating all the operations of its product line in ticking off a box memorizing the date. If this work is done later, it suffices to enter the date on which the operation has been performed. So long as the product line of an article is not terminated, it appears in the “state of the compound articles” indicator, in a different color, for example light blue.

It must be noted that a delay in the initial scheduling is seen in red, whereas a case in which the scheduled objective is met is identified by blue. The delays are propagated according to the initially defined structuring and layout pattern of the business operation. This highlights the potential consequences of these delays and enables the selection of action plans adapted to the situation.

When an article is out of order or being upgraded or still on loan to another entity, an entry zone is reserved for returns. This entry zone comprises for example sub-zones dedicated to the actions. For example, one box is used to tick off the start of the return, an expected end date or requested return date. One box is designed to indicate the date of return of the article in the island. During the time when the article is unavailable, the article appears on the <<state of the elementary articles>> indicator or <<state of the compound articles” indicator in red for example.

The principle of entry is simplified to the maximum so as to reduce the time spent in the tool.

The tool can generate several control assistance indicators, for example:
State indicating the availability of an article or sub-article,
State of the compound articles,
Production plan of the island or of an article and its offspring,
Production plan of a sub-contractor or supplier for all the business operations of the enterprise,
Progress of the integration of the different elements,
Table of delivered articles,
Table of articles in progress,
Table of returned articles,
Etc, any other indicator that may be useful for efficient business operation management.

Other indicators chosen as a function of the application may be added without departing from the scope of the invention. For example, as non-exhaustive examples, these indicators include:
the valuation of articles in progress, articles being repaired, etc.,
statistics on the duration of the cycle time,
statistics on the nature, quantities, durations, reports of returns per article,
Search for hard points in the production cycle (abnormal lengthening of schedules and viewing of chronologies),
Processing of customer returns,
The entirely automatic and instantaneous generation of all the indicators necessary for the managers of the business operations,
The viewing of the chronology of the events (multiple production runs of a line following problems encountered for example)
the viewing of coming activities in the week, the month or a number of days to be defined (choice offered).

The tool may include a form for the modification of contract dates, use modulate the schedule according to external events depending on the final customer for example. This corresponds to the principle of calls for delivery.

The different indicators provide the different actors with all the relevant information corresponding to their activity.

A tool according to be invention may consist of structural characteristics, detailed characteristics and complementary characteristics.

The structural characteristics are for example:
Management of the serial numbers of articles
Flow management
   Entry and exit of articles,
   Tracking of operations internal to the island by article and by copy,
   Tracking of the configuration applicable and applied by article and by copy,
   Tracking of returns by copy (repairs, upgrading, loan),
   Viewing of chronology by article and by copy.
Daily rescheduling of product line operations,
Simplification of the purchasing and manufacturing procedures needed for the efficient running of the business operation,
Setting up of a simple mechanism of calls for delivery to sub-contractors and suppliers of the firm,
Tracking of the sub-contracting stage delineators,
Announcements of important events of the week or month,
Single tool within all the island of the firm (delivery call, OF viewing . . . )
Ability to enter information by optical pencil,
Preparation of article-tracking cards,
Preparation of constitution of equipment (abbreviation: As-built),
Improvement of the ergonomy, access to commands,
Synthesis report on the availability of the articles,
Table of valuation of articles in progress,
Synthesis report of progress of product lines,
Constitution of equipment,
Synthesis table of forecast delivery calls,
Production plan,
Capacity to generate reports in the Excel format,
Coming events/monthly activity report/management chart.

The detailed characteristics are, for example:
Calls for delivery calls, in taking account of
   Integration times,
   Safety stocks,
Management of the configuration,
   Automatic comparison applicable/applied,
   Unique management of the applied configuration,
   Chronology of the developments of the configuration by copy.
Entry of names of operators and sub-contractors (returns, product lines),
Tracking of a return (cause of the return, tracking with a sub-contractor, indicator),
Specific nature of the customer return,
Preserving information proper to an article,
Management of hardware and human resources,
Management of operations linked to dispatch,
Tracking quality of products and capitalizing on observed malfunctions,
Impact of defects observed in the schedule.
Production plan with automatic forecasting but with possibility of manual shifting,
Progress of the cycle time,
Indicator of quality of the products delivered by the suppliers,
Indicator of quality of the products going out of the island,
Indicator of technical facts by business operation,
Indicator of technical facts by equipment,
Indicator of the ratio: time spent/time allocated.

Complementary characteristics are sometimes beyond the field of application but may be taken into account to improve the procedures.

The steps described here above can be applied, without departing from the framework of the invention, to the tracking and management of a project in industrial deployment.

What is claimed is:

1 - A system for the management of business operations or projects that brings into play several users Uij, the system comprising at least the following elements in combination:
a management controller adapted to the reception of data proper to a business operation and to the updating of this data on the basis of information delivered by the users,
a database containing the information needed for the management of a business operation or a project,
one or more interfaces between the management controller and the users.

2 - A system according to claim 1, wherein the management controller is adapted to controlling information introduced by a user for a given business operation or a given project.

3 - A system according to claim 1, wherein the management controller is adapted to the real-time generation of the updating of the information pertaining to the progress of a business operation or of a project.

4 - A system according to claim 3, wherein the management controller is adapted to the real-time generation of a timetable containing the dates of acceptance or delivery.

5 - A system according to claim 1, wherein the management controller is adapted to executing an initialization step for which the scheduling of a business operation or a project is prepared from a countdown schedule and possibilities of rescheduling in the event of modifications.

6 - A system according to claim 1, wherein a business operation is defined as being formed by one or more products formed by articles, themselves formed by one or more articles uip to the elementary articles delivered.

7 - A system according to claim 1, wherein the users are grouped in several islands (Ij) and the management controller is adapted to managing the information coming from the different islands.
